(19) United States
(12) Patent Application Publication
(10) Pub. No.: US 2012/0105969 A1
(43) Pub. Date: May 3, 2012

(54) METHOD FOR CALIBRATING A MULTILEAF COLLIMATOR

(76) Inventors: Christian Ehringfeld, Bayreuth (DE); Marco Köhler, Bayreuth (DE)

(21) Appl. No.: 13/249,161

(22) Filed: Sep. 29, 2011

(30) Foreign Application Priority Data
Sep. 30, 2010 (DE) DE102010041752.1

(51) Int. Cl. G02B 27/30

(52) U.S. Cl. 359/641

(57) ABSTRACT

Multileaf collimator calibration includes defining a reference position of a carriage and determining a first value, the first value being for a drift of a first position of a leaf from a first defined absolute position, the leaf being arranged on the carriage and the carriage being located at the reference position. The multileaf calibration also includes moving the carriage to a position to be checked and determining a second value, the second value being for a drift of a second position of a leaf from a second defined absolute position, the carriage being located at the position to be checked. A difference value is determined by forming the difference between the first value and the second value for the drift of the position of the leaf and using the difference value as a value for the drift of the position of the carriage for the position to be checked.

This application claims the benefit of DE 10 2010 041 752.1, filed on Sep. 30, 2011.

### BACKGROUND

The present embodiments relate to a method for calibrating a multileaf collimator.

In radiation therapy, multileaf collimators (MLC) are used for beam shaping. A multileaf collimator includes a plurality of leaves that may be moved independently of each other, so that a radiation area may be adjusted flexibly. The beam may be restricted to a relevant tissue to be irradiated.

FIGS. 1 and 2 show schematically how, using a multileaf collimator, a region to be irradiated (e.g., region of interest (ROI)) is predetermined. The multileaf collimator 61 has a housing 62 and also leaves 2 that may be adjusted in a direction of movement 63 using an adjustment mechanism. The adjustment mechanism is accommodated in the housing 62. The leaves 2 absorb rays of a ray 71 from a radiation source 70 (e.g., see FIG. 2). In FIG. 2, a radiation direction 65 (e.g., a beam direction) points perpendicularly into the imaging plane. The leaves 2 are adjustable towards each other up to a closed position 66, in which a space between end face surfaces 67 of the leaves 2 in relation to each other is minimal. By adjusting the leaves 2, an opening may be specified for a ray bundle passing through the multileaf collimator 61 in the beam direction 65, so that the cross section of the ray bundle passing through the device corresponds to a predefined radiation region of interest 68 except for edge zones 69.

A multileaf collimator may include two leaf carriers (e.g., carriages) that each carry a plurality of leaves (e.g., 80 leaves) arranged alongside one another and are arranged opposite one another with respect to a radiation field (not shown in FIGS. 1 and 2). Each of the 80 leaves of the carrier may be moved independently of the other leaves. A maximum radiation field may include a 40 cm×40 cm area. The leaves have a thickness of, for example, 5 mm so that the 80 leaves placed alongside one another cover the overall width of 40 cm. Each of the individual leaves may be moved a maximum of 20 cm out of the carriage. The length of the individual leaves (e.g., 20 cm) is restricted for reasons of material properties. The leaves consist of thin tungsten sheets that may be manufactured to a restricted length with the desired properties. The length of 20 cm enables the radiation field to also be fully closed along the length when the leaves are extended to full length from both sides. The exactness of precision with which the multileaf collimator operates has an important role to play for two reasons: it is to be provided that the corresponding region of tissue is irradiated as precisely as possible (e.g., the individual leaf positions are to be known exactly); and the multileaf collimator is entirely closable in subareas of the irradiation field. It is to be provided that there is no gap, because of tolerances between opposing leaves extended to their maximum length, for example. To have a greater flexibility in the adjustment of the region of interest, the leaf carriages may also be moved independently of one another in the direction of movement of the leaves. For example, a movement of the carriage by 5 cm enables the maximum length of the irradiation field to be reduced to 35 cm. Thus, the region of interest may be adjusted both by using the degree of freedom of the two leaf carriages and also the 160 leaves of the above example. The overall system is to be adjusted or calibrated so that tolerances or inaccuracies remain below a maximum threshold (e.g., the region of interest to be irradiated may be securely specified with sufficient accuracy).

Therapy devices may also include a device for positioning the patient. The positioning of the patient, which was previously undertaken using laser pointers and radiographic film images, may be carried out using Electronic Portal Imaging Devices (EPIDs). The overall arrangement is shown in greater detail in FIG. 3. FIG. 3 shows a system for radiation treatment 3. The system 3 contains a multileaf collimator (not shown in the diagram) that is arranged in a treatment head 4. The treatment head 4 is part of a gantry 6 that is attached to a stand 9 to allow the gantry 6 to rotate around an axis 8. This irradiation system may be used to irradiate a patient 13 that is supported on a patient couch 16. A therapeutic beam 10 is focused precisely on a region to be irradiated 12. A precise alignment of the therapeutic beam 10 onto the region to be irradiated 12 is necessary. To position the patient, an EPID 90 is attached to the gantry 6 so that, for any given rotational positions of the gantry, a position check may be undertaken. The EPID 90 includes a flat panel (e.g., an amorphous silicon detector in the form of a panel of photosensors). The detector unit that includes the EPID 90 is identified by reference number 91. This may record a dose 14 radiated from the patient and thereby provide access to monitoring. In addition, this device allows the characterization of beams generated by a linear accelerator of the system 3 (e.g., beam profile, dosimetric information such as field size, and energy).

There have been proposals to use such an Electronic Portal Imaging Device for verifying leaf positions in a multileaf collimator. This is described, for example, in the publication entitled “Verification of multileaf collimator leaf positions using an electronic portal imaging device” by Sunjiv S. Samant et al., published in Med. Phys. 29(12), December 2002. A position is determined using the EPID. The determination is repeated, and a difference is taken as the drift or deviation. This has the disadvantage that errors add up, (e.g., a first error already present in the first recording is added to the second recording) so that the difference between two positions and thus the overall error may not lie within an allowable corridor (e.g., range) for the error, although the difference between the two positions actually does lie within the allowable corridor for error.

This type of verification of the leaf positions may be supplemented by a mechanical calibration of the carriage positions. In a mechanical calibration, the carriage may be moved up to a defined stop, which functions as the reference point for the position. A calibration of leaves and carriages may take half an hour and is to be undertaken by service personnel with additional training for this task.

### SUMMARY AND DESCRIPTION

There is a need to make the calibration of a multileaf collimator simpler, more precise and faster so that time savings are achieved and the calibration no longer is to be undertaken by specialists but may be carried out by ordinary hospital personnel.

The present embodiments may obviate one or more of the drawbacks or limitations in the related art. For example, a less complex multileaf collimator system, including leaves and carriages, may be provided.

In one embodiment, a method, with which radiological positional drifts of a carriage may be determined, is provided.

The determination of a value for the drift of a position of a carriage of the present embodiments includes the following acts. No specific order of the acts is to be defined. The options that are sensible for the order of the acts are apparent to the person skilled in the art.

A reference position (e.g., a start position, from which the carriage may be moved) of the carriage is defined (e.g., act a). The reference position may, for example, involve a start position or a stop position, from which the carriage may be moved. For a maximum region of interest of 40 cm*40 cm, the reference position may correspond to the coordinate position −20 cm or +20 cm respectively.

A first value for the drift of the position of a leaf from a defined absolute position is determined (e.g., act b). The leaf is arranged on the carriage, and the carriage is at the reference position. The leaf has a defined leaf position (e.g., relative to the carriage). For example, the leaf is in the zero position or has moved out by a defined distance in terms of a restriction of a region of interest.

The carriage is taken or moved to a position of the carriage to be checked (e.g., act c). The leaf position (e.g., the relative position of the carriage and the leaf) remains unchanged. For the position to be checked, the drift of the carriage position from the setpoint position is defined below.

In a similar way to the determination of the first value for the drift, a second value for the drift of the position of the leaf from a defined absolute position is determined, with the carriage being located at a position to be checked (e.g., act d).

A difference value is determined by forming the difference between the first value and the second value for the drift of the position of the leaf (e.g., act e). It is a question of convention as to which value represents the minuend and which value represents the subtrahend. Any given drifts based purely on conventions may be included here.

The difference value is used as the value for the drift of position of the carriage for the position to be checked (e.g., act f). The position of the carriage may be corrected for drifts that lie outside an allowable error interval. Mechanical methods or software may be provided for position correction of the carriage. Smaller errors may also be compensated for by adapting the leaf positions.

The positional drift for the leaf may be determined directly by imaging methods. Based on this, the process of the present embodiments allows positional drift of the carriage, the position of which may not be obtained directly by imaging, to be determined without explicit measurement.

In one embodiment, a difference value is determined for a plurality of leaf positions of the leaf of the carriage. A mean value of the differences is used as the value for the drift of the position of the carriage for the position to be checked.

The methodical inaccuracies occurring for the drift of the position of a leaf from a defined absolute position are reduced by averaging.

In one embodiment, a plurality of positions to be checked may be defined in an area of movement of the carriage, and the positions may be checked to determine the drift of the position of the carriage in order to determine the carriage position over the entire area of movement and be able to correct the drift.

The drift of the leaf positions from the absolute position determined in acts b) and d) may be determined by imaging the leaf and comparing the image recorded with a reference image. The reference image may be defined with the aid of a detector whereby, for a defined detector position, a reference pattern (or a coordinate system) is defined by detector pixels (or coordinates assigned to detector positions). The detector is, for example, an EPID built into a radiotherapy system.

One embodiment of a procedure for defining the reference image includes recording a reference pattern using a detector and storing the reference pattern in the form of detected dose values and associated pixel positions (or coordinate values) of the detector. The DICOM standard also offers formats, with the aid of which the reference image may be stored. The reference image, instead of absolute dose values, may also contain standardized values or a processed pattern (e.g., only a maxima of coordinate lines identifying the radiation). The advantage of using a fixed reference pattern lies in avoiding the addition of errors, as occurs in conventional methods.

The present embodiments also include a radiotherapy system with a multileaf collimator and a control system for the multileaf collimator that is configured to execute one of the methods described.

### BRIEF DESCRIPTION OF THE DRAWINGS

FIG. 1 shows a multileaf collimator in a plane at right angles to a radiation direction;

FIG. 2 shows a side view of a radiation source with a multileaf collimator;

FIG. 3 shows an irradiation device with an Electronic Portal Device;

FIG. 4 shows a first act for one embodiment of calibrating a multileaf collimator;

FIG. 5 shows one embodiment of a determination of a drift of leaf positions;

FIG. 6 shows one embodiment of an image recorded by the detector in a determination in accordance with FIG. 5;

FIG. 7 shows one embodiment of a procedure for determining leaf positions; and

FIG. 8 shows one embodiment of a determination of the carriage positions.

### DETAILED DESCRIPTION OF THE DRAWINGS

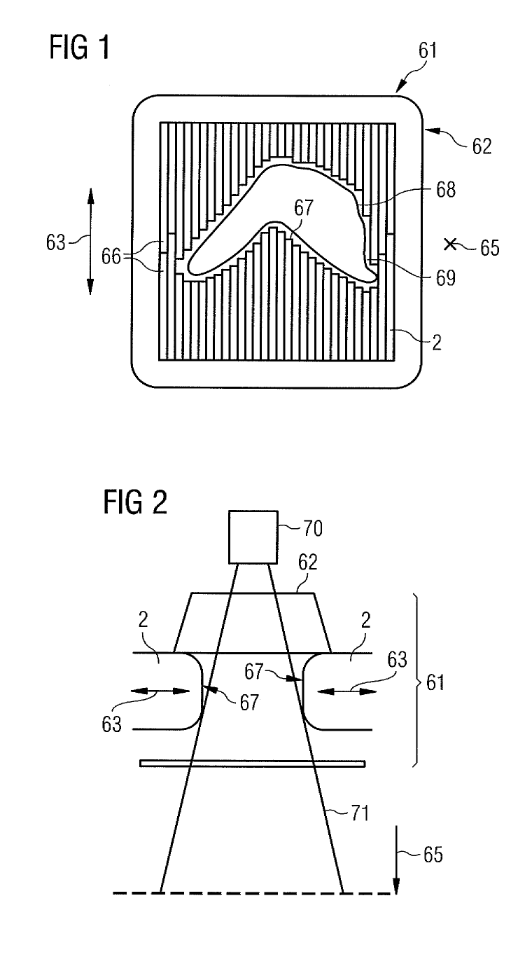

FIG. 1 and FIG. 2 show one embodiment of a multileaf collimator, in which a beam is shaped using leaves in accordance with a region to be irradiated. Multileaf collimators may have, for example, 80 leaves on both sides with a thickness of 0.5 cm.

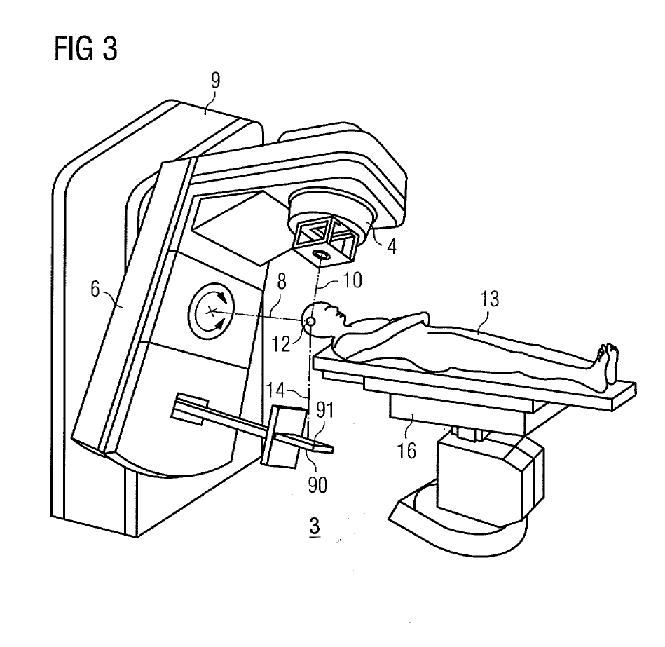

FIG. 3 shows a radiotherapy system with an Electronic Portal Imaging Device.

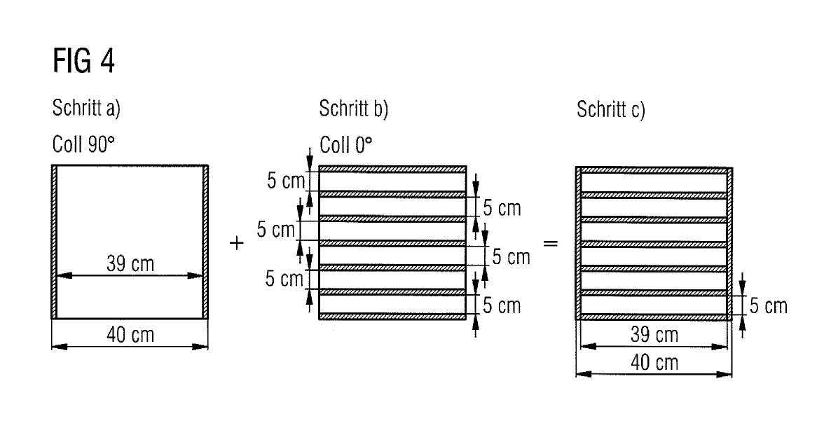

FIG. 4 shows a first act of one embodiment of a calibration. This first act may not involve the multileaf collimator and a flat panel of the EPID matching one another (e.g., both the multileaf collimator and the flat panel being turned towards one another). Instead, the multileaf collimator and the flat panel may be able to make an angle with one another. In order to compensate for this lack of synchronization of the orientation or to take account of this lack of synchronization, one embodiment of the procedure is shown in FIGS. 4-7. A first recording is made with an orientation of the multileaf collimator (e.g., labeled 90° in FIG. 4). In the first recording, two outermost leaves are fully extended, and a remainder of the region is left free (act a). Each of the two outermost leaves has, for example, a thickness of 5 mm, so that a distance between the two outermost leaves is 39 cm (e.g., for a 40 cm×40 cm maximum region of interest). After the first recording, as shown in act b, the multileaf collimator is turned by 90° and a second recording, in which the pair of leaves is closed by 5 cm, is made. This produces a type of ladder-shaped recording structure. In act c, the first recording and the second recording (e.g., two images are overlaid so that a reference frame is produced). The reference frame forms a type of coordinate system, using which the multileaf collimator may be calibrated and drifts or inaccuracies corrected. The detector used has a pixel panel. Pixels of the pixel panel are assigned coordinates (X,Y) in accordance with the DICOM standard. Thus, using the imaging from FIG. 4, the calibration field may be assigned to spatial positions (e.g., at least in two dimensions).

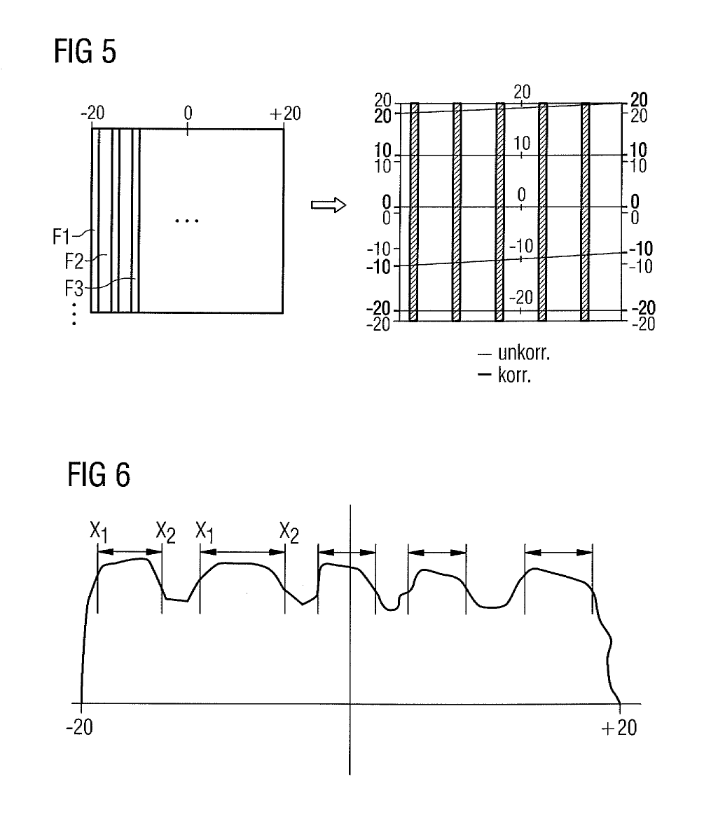

FIG. 5 is used as a basis showing how the process operates during the calibration of leaves. This involves a Fence Test. For individual leaves 1 to 80 (e.g., first side) or 81 to 160 (e.g., second side), the extent to which the individual leaves deviate from positions of the coordinate system is established. An example of an image for such a recording in a Fence Test is shown in FIG. 6.

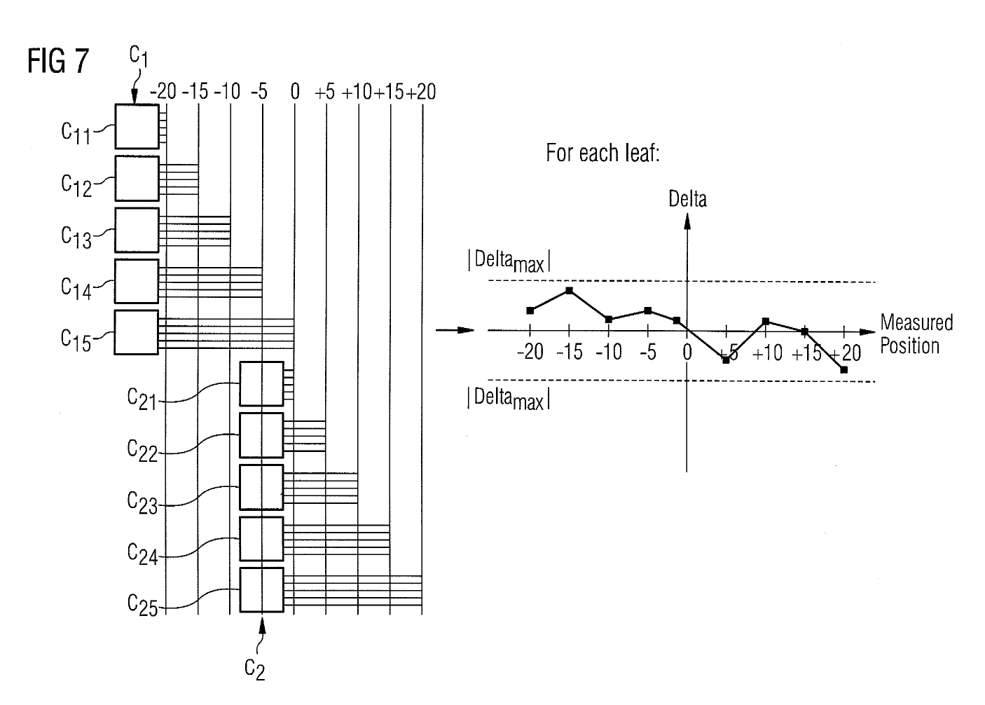

FIG. 7 shows a first act of one embodiment for taking account of the carriages. Shown schematically on the left-hand side is a carriage in two different positions C1 and C2. The two different positions correspond to −20 and 0. Leaves are indicated in each case by four lines. For the two carriage positions, five different leaf positions, C11 to C15 or C21 to C25, are shown. These leaf positions correspond at the first carriage position to positions −20, −15, −10, −5 and 0 of the leaves and in the second carriage position to the leaf positions 0, +5, +10, +15 and +20. The right-hand side of the figure shows that for each position of the leaves (e.g., −20, −15 . . . +20), the drift from a setpoint position is determined. The drift from the setpoint position may move within a defined corridor (−Deltaₘₐₓ, +Deltaₘₐₓ.).

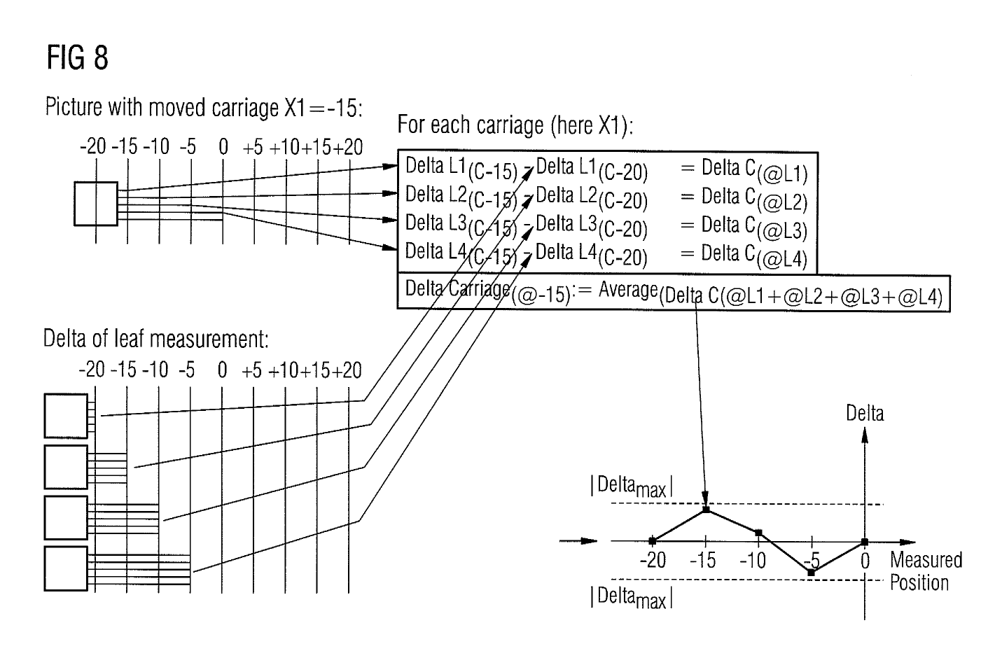

FIG. 8 shows how, using these methods, an error or the drift for the carriage position may be determined. The top left of FIG. 8 shows that for a carriage position of −15, the error (e.g., Delta) is determined for different leaf positions.

In the bottom left of FIG. 8, measurements are taken for the carriage position 0, which is the reference position. Errors for the different leaf positions are also determined at the reference position. By subtracting the errors from one, another the error or the drift of the carriage at the carriage position −15 is determined. The bottom right of the FIG. 8 shows that in this way, a determination of the drift at the carriage position for different carriage settings may be determined and thus also corrected.

The errors for the dosimetrically or radiologically invisible carriages may also be determined via the leaves.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for determining a value for a drift of a position of a collimator leaf carriage, the method comprising:
defining a reference position of the collimator leaf carriage;
determining a first value for a drift of a first position of a leaf from a first defined absolute position, the leaf being arranged on the collimator leaf carriage and the collimator leaf carriage being located at the reference position;
moving the collimator leaf carriage to a position to be checked;
determining a second value, the second value being for a drift of a second position of the leaf from a second defined absolute position, the collimator leaf carriage being located at the position to be checked;
determining a difference value by forming the difference between the first value and the second value for the drift of the position of the leaf; and
using the difference value as a value for the drift of the position of the collimator leaf carriage for the position to be checked.

2. The method as claimed in claim 1, wherein difference values are determined for a plurality of leaf positions of the leaf of the collimator leaf carriage, and a mean value of the difference values is used as a value for the drift of the position of the collimator leaf carriage for the position to be checked.

3. The method as claimed in claim 1, wherein a plurality of positions to be checked is determined in an area of movement of the collimator leaf carriage, and
wherein the drift of the position of the collimator leaf carriage is determined for the plurality of positions to be checked.

4. The method as claimed in claim 1, wherein the position to be checked, to which the collimator leaf carriage is movable, is corrected in accordance with the value for the drift.

5. The method as claimed in claim 1, wherein determining the first value comprises determining the drift of the first position by recording a first image of the leaf and comparing the recorded first image with a reference image, and
wherein determining the second value comprises determining the drift of the second position by recording a second image of the leaf and comparing the recorded second image with the reference image.

6. The method as claimed in claim 5, wherein the reference image is determined with the aid of a detector, and
wherein a reference pattern is defined by detector pixels for a defined detector position.

7. The method as claimed in claim 2, wherein the position to be checked, to which the collimator leaf carriage is movable, is corrected in accordance with the value for the drift.

8. The method as claimed in claim 2, wherein determining the first value comprises determining the drift of the first position by recording a first image of the leaf and comparing the recorded first image with a first reference image, and
wherein determining the second value comprises determining the drift of the second position by recording a second image of the leaf and comparing the recorded second image with a second reference image.

9. The method as claimed in claim 3, wherein determining the first value comprises determining the drift of the first position by recording a first image of the leaf and comparing the recorded first image with a reference image, and
wherein determining the second value comprises determining the drift of the second position by recording a second image of the leaf and comparing the recorded second image with the reference image.

10. The method as claimed in claim 4, wherein determining the first value comprises determining the drift of the first position by recording a first image of the leaf and comparing the recorded first image with a reference image, and
wherein determining the second value comprises determining the drift of the second position by recording a second image of the leaf and comparing the recorded second image with the reference image.

11. A method for determining reference images and carrying out a method for determining a value for a drift of a position of a collimator leaf carriage based on the reference image, the method comprising:
defining a reference position of the collimator leaf carriage;
determining a first value for a drift of a first position of a leaf from a first defined absolute position, the leaf being arranged on the collimator leaf carriage and the collimator leaf carriage being located at the reference position;
moving the collimator leaf carriage to a position to be checked;
determining a second value, the second value being for a drift of a second position of the leaf from a second defined absolute position, the collimator leaf carriage being located at the position to be checked;
determining a difference value by forming the difference between the first value and the second value for the drift of the position of the leaf;
using the difference value as a value for the drift of the position of the collimator leaf carriage for the position to be checked;
recording a reference pattern using a detector; and
defining and storing the reference pattern in the form of detected dose values and associated pixel positions of the detector.

12. An irradiation system comprising:
a multileaf collimator; and
a control system for the multileaf collimator, the control system being configured to:
define a reference position of the collimator leaf carriage;
determine a first value for a drift of a first position of a leaf from a first defined absolute position, the leaf being arranged on the collimator leaf carriage and the collimator leaf carriage being located at the reference position;
move the collimator leaf carriage to a position to be checked;
determine a second value, the second value being for a drift of a second position of the leaf from a second defined absolute position, the collimator leaf carriage being located at the position to be checked;
determine a difference value by forming the difference between the first value and the second value for the drift of the position of the leaf; and
use the difference value as a value for the drift of the position of the collimator leaf carriage for the position to be checked.

13. A non-transitory computer-readable medium that stores instructions executable by a processor to perform a method for determining a value for a drift of a position of a collimator leaf carriage, the method comprising:
defining a reference position of the collimator leaf carriage;
determining a first value for a drift of a first position of a leaf from a first defined absolute position, the leaf being arranged on the collimator leaf carriage and the collimator leaf carriage being located at the reference position;
moving the collimator leaf carriage to a position to be checked;
determining a second value, the second value being for a drift of a second position of the leaf from a second defined absolute position, the collimator leaf carriage being located at the position to be checked;
determining a difference value by forming the difference between the first value and the second value for the drift of the position of the leaf; and
using the difference value as a value for the drift of the position of the collimator leaf carriage for the position to be checked.
